(19) United States
(12) Patent Application Publication
(10) Pub. No.: US 2017/0314860 A1
(43) Pub. Date: Nov. 2, 2017

(54) MELTING DEVICE AND MELTING METHOD

(71) Applicants: Gerhard FUCHS, Kehl-Bodersweier (DE); eco-e AG, Pfaffikon (CH)

(72) Inventor: Gerhard FUCHS, Kehl-Bodersweier (DE)

(73) Assignee: eco-e AG, Pfaffikon (CH)

(21) Appl. No.: 15/522,825

(22) PCT Filed: Oct. 28, 2015
(86) PCT No.: PCT/DE2015/100454

§ 371 Date: Apr. 28, 2017

(30) Foreign Application Priority Data
Oct. 28, 2014 (DE) 10 2014 115 671.4

(51) Int. Cl. F27D 13/00; F27D 11/08; C21C 5/56; F27B 14/02; F27B 3/18; F27D 99/00; F27B 14/06; F27B 14/08

(52) U.S. Cl. CPC F27D 13/002; F27D 99/0076; F27D 11/08; F27B 14/06; C21C 5/565; F27B 14/02; F27B 3/183; F27B 2014/085

(57) ABSTRACT

The present invention relates to a melting device comprising a loading shaft (13, 13a) and a tilting device (4) by means of which a furnace vessel (1) with a furnace vessel cover (10) can be tilted into different tilt positions around a tilt axis (5a), wherein the furnace vessel sealing region is formed as a convex, cylindrical mantel section shaped, surface, and the shaft sealing region of the loading shaft (13, 13a) is formed as a complementary concave, cylindrical mantel section shaped, sealing surface, such that sections of the sealing surfaces of the two sealing regions lie mutually opposite one another in the different tilt positions of the tilting device (4) such that the transition region between the loading shaft (13, 13a) and the furnace vessel (1) is at least substantially sealed in all tilt positions of the furnace vessel (1), and to a melting method, in which a bunker container (17, 17a) with charging material (39, 40, 41) is placed in front of the loading shaft (13, 13a) on the loading side, wherein over the further course of this method, the charging material (39, 40, 41) is preheated in the bunker container (17) by furnace gas, and after further transport of this charging material (39, 40, 41) from the bunker container (17, 17a) into the loading shaft (13), this charging material (39, 40, 41) is further preheated in the loading shaft (13) by furnace gas.

The present invention relates to a melting device according to the preamble of claim 1 and to a melting method according to the preamble of claim 16.

A melting device which is disclosed in DE 34 21 485 and has been developed by the inventor of the present invention, includes a furnace vessel and a charging material feed device, wherein the charging material feed device comprises a charging material shaft which is realized as a charging material pre-heating device, and wherein the charging material pre-heating device is set up to pre-heat charging material in the charging material feed shaft by means of furnace gas. The charging material is melted in melting cycles. Each melting cycle includes the feeding with several charges up to the tapping (casting of the melt). The individual charges pass through the charging material feed shaft into the furnace vessel. Whilst the first charge is being melted, for example, in the furnace vessel, the second charge is first of all poured into the charging material feed shaft and is pre-heated there. A disadvantage of said melting device is that it is not possible to pre-heat the first charge, which is associated with a following melting cycle, by means of furnace gas before the tapping for the preceding melting cycle is effected, as the first charge of the following melting cycle would get in the way of the tapping. This results in an inefficient use of energy.

In order to eliminate said disadvantage, blocking elements are used in a more recent melting device which is disclosed in DE 39 40 558 and has also been developed by the inventor of the present invention. On account of the blocking elements, the first charge, which is associated with a following melting cycle, can already be poured into the charging material feed shaft and pre-heated by means of furnace gas before the tapping is effected for the preceding melting cycle, the blocking elements preventing the first charge of the following melting cycle sliding into the furnace vessel during the tapping and obstructing the tapping. Water cooling is used, as a rule, for the blocking elements. A disadvantage of said melting device is that a large amount of energy is required for said water cooling. The blocking elements are additionally exposed to thermal stress and can be damaged by thudding charging material. EP 0 971 193 also discloses blocking elements which alleviate the difficulties connected thereto. However, said blocking elements also require a large amount of energy for the water cooling.

DE 20 2010 016 851 discloses a melting device which comprises a charging material feed shaft which is not realized as a charging material pre-heating device, but comprises a charging material bunker which is realized as a charging material pre-heating device. Said melting device does not require any blocking elements. No pre-heating takes place in the charging material feed shaft. The furnace gas which is used to pre-heat the charging material in the charging material bunker, has hardly cooled when it reaches the charging material bunker, which is why the charging material bunker is realized with water cooling. Said cooling requires a large amount of energy.

In addition, the furnace gas still has a high temperature when it leaves the charging material bunker. In order to use said thermal energy of the furnace gas to also pre-heat the charging material, an additional charging material pre-heating device is necessary which requires additional structural expenditure.

WO 2012/062254 discloses a melting device having a furnace vessel and a charging material feed device, the charging material feed device comprising a charging material shaft and charging material bunker, the charging material shaft being realized as a charging material pre-heating device, the charging material pre-heating device being set up to pre-heat charging material in the charging material feed shaft by means of furnace gas. The melting device is additionally realized in such a manner that hardly any furnace gas passes in an uncontrolled manner into the environment. In addition, the melting device does not require blocking elements. The charging material shaft is realized and arranged in such a manner that charging material passes through the charging material shaft into the furnace vessel not just due to gravity. A slider is provided in order to move the charging material out of the charging material shaft into the furnace vessel. The charging material bunker is separated from die charging material shaft by a horizontally drivable partition wall. Said partition wall is driven together with a horizontally drivable slider which conveys the charging material from the charging material bunker into the charging material shaft. In this case, the partition wall itself moves into the charging material shaft and cannot be moved back until the charging material column has dropped sufficiently in the charging material shaft, whereupon a further charge is only then able to be poured into the charging material bunker and then forwarded into the charging material shaft in order to be pre-heated there. The time required until the partition wall is moved back, is consequently not available for the pre-heating of the further charge. In practice, it has also been shown that the partition wall is quickly damaged such that furnace gas is able to escape in an uncontrolled manner through the damaged partition wall when the charging material bunker is being loaded.

A inciting device having a pivoting device in order to pivot a furnace vessel into different pivot positions is disclosed in DE 39 06 653. The furnace vessel comprises a furnace vessel opening. The feed shaft comprises a shaft opening. During the melting operation of the melting device, charging material slides from the feed shaft through the shaft opening and through the furnace vessel opening into the furnace vessel. When the slag or the melt is to be poured out, the furnace vessel has to be pivoted by means of the pivoting device. To this end, however, it is first of all necessary to lift up the feed shaft and move it to the side. This results in an opening, through which furnace gas is able to escape or air is able to be drawn in, which results in a loss of thermal energy.

The object underlying the present invention is to create a melting device and a melting method which are particularly energy-efficient.

The object underlying the invention is achieved by a melting device with the features of the characteristic part of claim 1 and by a melting method with the features of the characteristic part of claim 16.

The present invention relates to a melting device having a tilting device in order to tilt the furnace vessel into different tilt positions, wherein the furnace vessel comprises a furnace vessel sealing region. with a sealing surface which surrounds a furnace vessel opening, wherein the feed shaft, which is associated with the furnace vessel, comprises a shaft sealing region with a complementary sealing surface which surrounds the shaft opening of the feed shaft, and wherein the sealing surface is situated opposite the complementary sealing surface for different tilt Positions of the tilt device. The loss of thermal energy is reduced as a result of the unwanted outflow of furnace gas being prevented at least extensively by means of extensively abutting sealing surfaces. The loss of thermal energy is also reduced as a result of the unwanted drawing-in of air and the resultant heating of said air being prevented. As a result, the energy efficiency of the melting device is increased. In addition, the air quality in the room in which the melting device is situated is improved.

In a preferred embodiment, the sealing surface of the furnace vessel sealing region is a convex, cylinder-surface-portion-shaped surface and the complementary sealing surface of the shaft sealing region comprises a complementary concave, cylinder-surface-portion-shaped contour. A cylinder-surface-portion-shaped surface, in conjunction with the present invention, is a surface which lies on a (fictitious) cylinder surface. The axes of the cylinders on which the cylinder-surface-portion-shaped surface or contour lies preferably coincide with a rotational axis about which the tilting device is tilted, at least one pivot joint preferably being located on the rotational axis. The complementary sealing surface of the feed shaft preferably comprises, on two opposite sides, two sealing elements which project beyond the sealing surface of the furnace vessel sealing region in a tilt position.

In another preferred embodiment, which is also usable independently of the preceding realization of the invention, a charging material bunker, which is situated upstream of the feed device, comprises a feed opening with a feed opening closure element and a loading opening with a loading opening closure element. The charging material shaft is preferably connected to the charging material bunker by means of the feed opening. The charging material is preferably loaded into the charging material bunker through the loading opening. During the filling of the charging material bunker when the loading opening is open, the feed opening closure element prevents furnace gas flowing out of the feed shaft into the charging material bunker and then further through the loading opening. Once the charging material bunker has been filled when the feed opening is open, the feed opening closure element prevents furnace gas flowing out of the charging material bunker through the loading opening. The loading opening closure element and the feed opening closure element also prevent air being drawn-in from the outside. The loss of thermal energy is reduced as a result of preventing the unwanted outflow of furnace gas. The loss of thermal energy is also reduced as a result of preventing air being drawn-in in an unwanted manner and the resultant heating of said air. As a result, the energy efficiency of the melting device is further increased. In addition, the air quality in the room in which the melting device is situated is improved.

The feed opening closure element is preferably displaceable, movable or drivable into a region outside the charging material shaft for opening the feed opening. Charging material which is situated in the charging material shaft does not then obstruct the closing of the feed opening by the feed opening closure element such that the feed opening can be closed in good time, and a further charge can consequently be poured into the charging material bunker in good time in order to be pre-heated there. A guide means is preferably provided, along which the feed opening closure element is displaceable, movable or drivable. The feed opening closure element is preferably drivable in a vertical manner. The movement direction of the feed opening closure element therefore preferably has a vertical component, the vertical component preferably being greater than a horizontal component of the movement direction. A drive device is preferably provided in order to drive the feed opening closure element along the guide means. The loading opening closure element is preferably drivable in a horizontal manner. The movement direction of the loading opening closure element therefore preferably has a horizontal component, the horizontal component preferably being greater than a vertical component of the movement direction. A drive device is preferably provided in order to drive the loading opening closure element along a guide means.

The charging material bunker opens above the feed opening into the feed shaft which, in an advantageous realization, is provided with a gas outlet. Furnace gas can be drawn off by means of said gas outlet opening for instance by means of a gas channel. To this end, the feed opening of the feed shaft must be closed by means of a closure element. The furnace gas which flows through the feed shaft to the gas outlet heats, in a manner as intended, the charging material which is received in the feed shaft in the sense of pre-heating.

In yet another preferred embodiment, the charging material bunker comprises a further gas outlet opening. Furnace gas is drawn out of the charging material bunker through the gas outlet opening in particular when the loading opening is closed by the loading opening closure element and the feed opening is open such that the furnace gas is able to flow through the feed shaft into the charging material bunker. A gas channel preferably opens out into the further gas outlet opening. A gas suction device draws the furnace gas off through the gas channel. Said gas suction device can be identical to the aforenamed gas suction device. The further gas outlet opening is preferably arranged on an end of the charging material bunker which is remote from the feed opening of the feed shaft.

In a further development of the last-named preferred embodiment, a gas channel opens out in the gas outlet opening; the gas channel comprises a channel portion which runs beneath a floor of a bunker container of the charging material bunker to a pipe joint which is located in a rotational axis of the bunker container. This ensures that the extraction of the furnace gas through the channel portion does not impair the pivotability of the bunker container. A further channel portion preferably opens out in the pipe joint in order to forward furnace gas. The channel portions are preferably realized as pipes. In conjunction with the present invention, a pipe joint is a device which produces an articulated fluid connection between at least two pipes or the like. In an advantageous manner, said further development manages with a minimum of pipe joints and pipe portions.

In yet another preferred embodiment which is also usable independently of the previous designs of the invention, a furnace gas inhibiting device is provided with a blower. The blower is preferably provided in a passage between two regions and interrupts or obstructs at least the flowing of furnace gas from one of the regions to another of the regions by the blower blowing in a gas, preferably air, along a cross sectional surface of the passage. As a result, the air quality in the room in which the melting device is situated can be improved. The furnace gas inhibiting device makes it possible to dispense with a mechanical closure element in a region in which, in particular, damage can occur as a result of the charging material. In this case, the furnace gas inhibiting device is mounted so as to be pivotable preferably at the top of a passage, the furnace gas inhibiting device preferably being able to be pivoted up and down. The furnace gas inhibiting device preferably includes a partition wall. Said partition wall can block an upper part of a passage such that the flowing of furnace gas only has to be inhibited. in a lower part of the passage by blowing in gas or air where charging material, as a rule, is exclusively to be found. As an alternative to this, a driving device can also be provided in order to drive the furnace gas inhibiting device up and down.

In a further development of the last-named preferred embodiment, the furnace gas inhibiting device is provided in the charging material feed shaft. The furnace gas inhibiting device inhibits a flow of furnace gas from the charging material feed shaft to a bunker container, from where it could escape. The furnace gas inhibiting device is preferably provided downstream of a gas outlet opening in the charging material feed shaft such that furnace gas can be drawn in through the gas outlet opening in the charging material feed shaft.

In yet another preferred embodiment, which is also usable independently of the previous realizations of the invention, a pivoting device is provided for an additional charging material container in order to pivot the additional charging material container from a loading position to an unloading position and vice versa, and the pivoting device comprises two support arms in order to hold the additional charging material container on two opposite sides. A closable unloading opening is preferably situated on the floor of the additional charging material container. The pivoting device can be used, above all, on account of space restrictions.

The present invention additionally relates a melting device having a furnace vessel and a charging material feed device, wherein the charging material feed device comprises a charging material shaft and a charging material bunker, wherein the charging material shaft is realized as a charging material pre-heating device, wherein the charging material pre-heating device is set up to pre-heat charging material in the charging material feed shaft by means of furnace gas, wherein the charging material bunker is realized as a further charging material pre-heating device, and wherein the further charging material pre-heating device is set up to pre-heat charging material in the charging material bunker by means of furnace gas. In conjunction with the present invention, the charging material pre-heating device is then set up to pre-heat the charging material in the feed shaft by means of furnace gas (gas from a melting vessel interior) when the charging material feed shaft includes a space, through which the furnace gas flows out of the furnace vessel on account of a pressure difference which is produced, for example, by a suction device which draws off the furnace gas, wherein the space additionally contains a charge of charging material during a normal melting operation for a substantial time of at least one minute, preferably five minutes, even more preferred at least ten minutes. The charging material can move in the space whilst it is contained therein. The space can be suitable, for example, on account of particular dimensioning, to contain charging material for a considerable time during a normal melting operation. For example, the form, realization or dimensioning of the melting vessel and/or feed shaft can result in a charging material column forming in the feed shaft. In an analogous manner, in conjunction with the present invention, the further charging material pre-heating device is set up then to pre-heat charging material in the charging material bunker by means of furnace gas (gas from a melting vessel interior) when the charging material bunker includes a further space, through which the furnace gas flows out of the furnace vessel on account of a pressure difference which is produced, for example, by a suction device which draws off the furnace gas, wherein the further space contains a charge of charging material for a substantial time of at least one minute, preferably five minutes, even more preferred at least ten minutes during a normal melting operation. The charging material shaft is preferably realized and/or provided in such a manner that charging material passes from the charging material shaft into the furnace vessel due to gravity such that no further device is necessary to convey the charging material from the charging material shaft into the furnace vessel. This can be achieved, in particular, by means of realizing an upwardly pointing wall inside surface of the charging material shaft in an inclined manner and the position of the passage from the charging material shaft to the furnace vessel at the top of the furnace vessel.

The achievement of combining the feed shaft, which is realized as a charging material pre-heating device, with the charging material bunker, which is realized as a charging material pre-heating device, is that furnace gas, which flows from the feed shaft to the charging material bunker, has already cooled considerably. Consequently, the charging material bunker does not have to comprise any or hardly any cooling devices which, in turn, use energy. When the furnace gas has flowed out of the charging material bunker, it is additionally already greatly cooled such that no further pre-heating device is necessary in order to draw the thermal energy out of the furnace gas and avoid wasting energy as a result. The combination therefore achieves a synergetic effect. Approximately five percent of the energy required for the melting method is saved by dispensing with water-cooled. blocking elements.

According to valid claim 10, the realization of which is also independently usable, the bunker can be arranged on a platform so as to be drivable in such a manner that it is moved by means of a carriage up to a tilting device, by means of which the emptying of the bunker container of the bunker into the feed shaft of the melting device is made possible. The advantage of this is that the bunker containers with the charging material which can be inserted into the bunker only have to be lifted by such an amount above the height of the platform until said bunker containers are able to be inserted or emptied into the bunker. In other words, this means that the bunker containers do not have to be lifted, for instance, to a height above the feed opening of the feed shaft which means that the melting device, as a rule, is able to be supplied using the existing cranes. No new or additional cranes, which would make it possible to lift the bunkers to a height above the feed opening of the feed shaft, have to be purchased. In addition, correspondingly, for instance the height of existing buildings does not need to be increased for receiving the melting device according to the invention such that the melting device according to the invention can be set up in an existing building.

According to an advantageous further development said solution, the platform is realized such that, in addition to the bunker which has already been moved up to the feed opening of the feed shaft for the purposes of emptying, a further bunker can be arranged on the platform on the same rail arrangement such that the first bunker, once it has been emptied, can be removed to the side and then the further bunker can be driven on the platform up to the feed opening of the feed shaft by means of the carriage for the purposes or emptying. This means that, in the case of said realization, there is no longer a requirement to lift up a subsequently provided bunker container above the bunker that has just been emptied in order then to fill said bunker with the charging material of the subsequently provided bunker container through the loading opening thereof. In said case, the crane has therefore only to lift the subsequently provided bunker container above the platform, but not above the further bunker which is already situated on the platform. As a result, the melting device according to the invention can. be used in conjunction with a crane which is designed with a lower height or rather can also be used in a building which is lower in height.

In a, once again, advantageous further development of the invention, the platform can be provided additionally with its own lifting device for a further bunker container. In said case too, a further bunker container which is provided subsequently by means of the crane has then only to be lifted to a height that enables it to be set onto the rail arrangement of the platform, the subsequently provided bunker container then being raised by means of a lifting device which is associated with the platform and being moved up to the just emptied bunker in such a manner that the subsequently provided bunker container can then be emptied into the bunker container of the bunker which has just been emptied into the feed shaft. Said solution also ensures that the melting device is feedable using an existing crane and, apart from this, there is no need either for a higher building.

In a further advantageous design, the lifting device is additionally designed such that by means of said lifting device, a subsequently provided bunker container is pivotable by means of the lifting device. The advantage of this is that the subsequently provided bunker or bunker container can also be placed onto the platform transversely with respect to the bunker which has already been moved up to the feed shaft, that is to say not in the longitudinal direction, but in the transverse direction such that in the case of said design a shorter platform can be used and also the space required. for the melting device is accordingly reduced.

In an alternative design, the lifting device is not incorporated in the platform for parking the bunker or bunker container, but is arranged to the side next to said platform such that the subsequently provided bunkers or bunker containers are not deposited behind the bunker which has already been moved up to the feed shaft for the purposes of emptying, but rather next to the already postioned bunker, the space requirement also being reduced accordingly in the case of said realization.

The present invention additionally relates to a melting method which is carried out by a melting device having a furnace vessel and a charging material feed device, wherein the charging material feed device comprises a feed shaft and a charging material bunker with a bunker container, said method having the following steps:
pre-heat the charging material in the bunker container by means of furnace gas; forward the charging material from the bunker container into the feed shaft; pre-heat the charging material in the feed shaft by means of furnace gas.

In conjunction with the present invention, pre-heating the charging material by means of furnace gas means that the charging material is exposed to the furnace gas during a normal melting operation for a substantial time of at least one minute, preferably five minutes, even more preferred at least ten minutes. The pre-heating of the charging material in the feed shaft by means of furnace gas lasts therefore for a time at least one minute, preferably five minutes, even more preferred at least ten minutes. During the pre-heating of the charging material in the charging material bunker by means of furnace gas, the charging material can move in the charging material bunker. The pre-heating of the charging material in the feed shaft by means of furnace gas lasts therefore for a time of at least one minute, preferably five minutes, even more preferred at least ten minutes. During the pre-heating of the charging material in the feed shaft by means of furnace gas, the charging material can move in the feed shaft.

In a preferred embodiment, the melting method includes several charges of charging material, wherein for one of the several charges of charging material the following steps are carried out one after another:
pour the charge into the bunker container through the loading opening; close the loading opening; open the feed opening; pre-heat the charge in the bunker container by means of furnace gas; forward the charge from the bunker container into the feed shaft and pre-heat the charge in the feed shaft by means of furnace gas.

The pre-heating in the feed shaft is not necessarily carried out for each charge. The pre-heating in the feed shaft, for example, can be omitted for a first charge in a melting cycle because the first charge slips through the feed shaft. The detail of the individual method steps can differ, in this case, for different charges. For example, the forwarding of a third charge can last much longer than the forwarding of a first charge, because charging material in the feed shaft obstructs the sliding of the third charge into the feed shaft. The pre-heating in the bunker container also then lasts longer. The feed opening is preferably opened and closed by means of displacing, moving or driving a feed opening closure element, the feed opening closure element being displaced, moved or driven into a region outside the charging material shaft during the opening of the feed opening. Charging material which is situated in the charging material shaft does not then obstruct the closing of the feed opening by the feed opening closing element such that the feed opening can be closed in good time and a further charge can be filled in the charging material bunker in good time in order to be pre-heated there.

In an alternative preferred embodiment, the melting method includes several charges of charging material, wherein for one of the several charges of charging material the following steps are carried out one after another:
pour the charge into the bunker container through a loading opening whilst the entry of furnace gas into the bunker container is inhibited by a furnace gas inhibiting device; close the loading opening; pre-heat the charge in the bunker container by means of furnace gas; forward the charge from the bunker container into the feed shaft; pre-heat the charge in the feed shaft by means of furnace gas.

In a further development of the two last-named preferred embodiments, the bunker container is tilted in order to forward the charge into the feed shaft. As an alternative to this, a slider can be provided in order to forward charging material out of the bunker container into the feed shaft.

The invention is described in more detail below with reference to the drawings, in which:

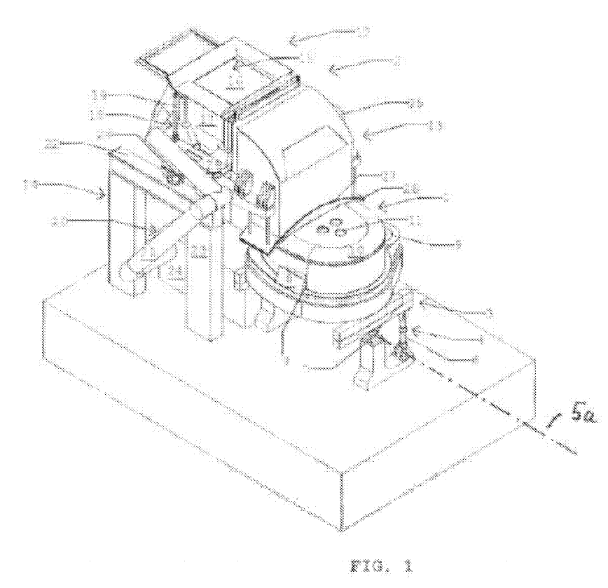

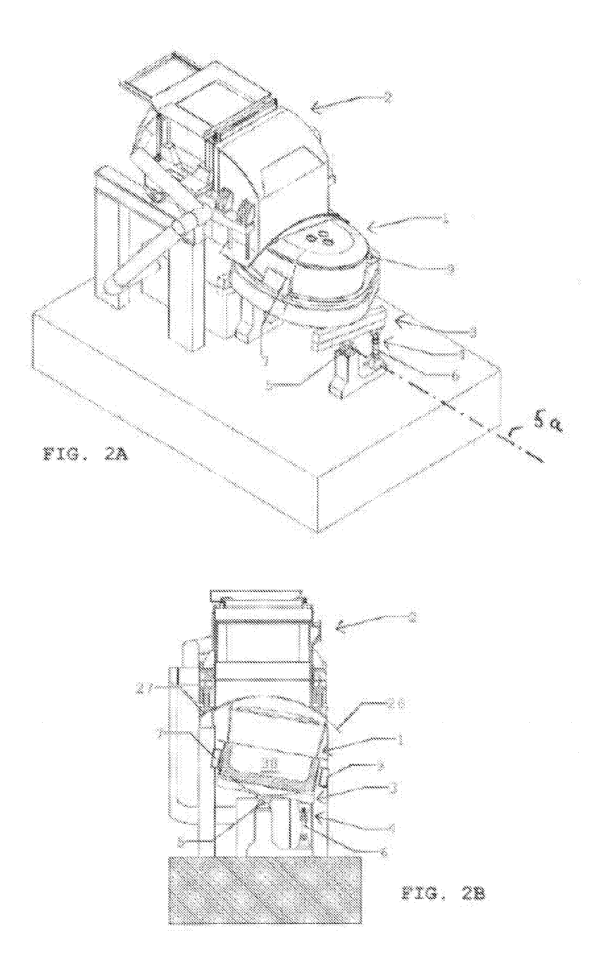

FIG. 1 shows a perspective view of a melting device according to a first embodiment in a melting position;

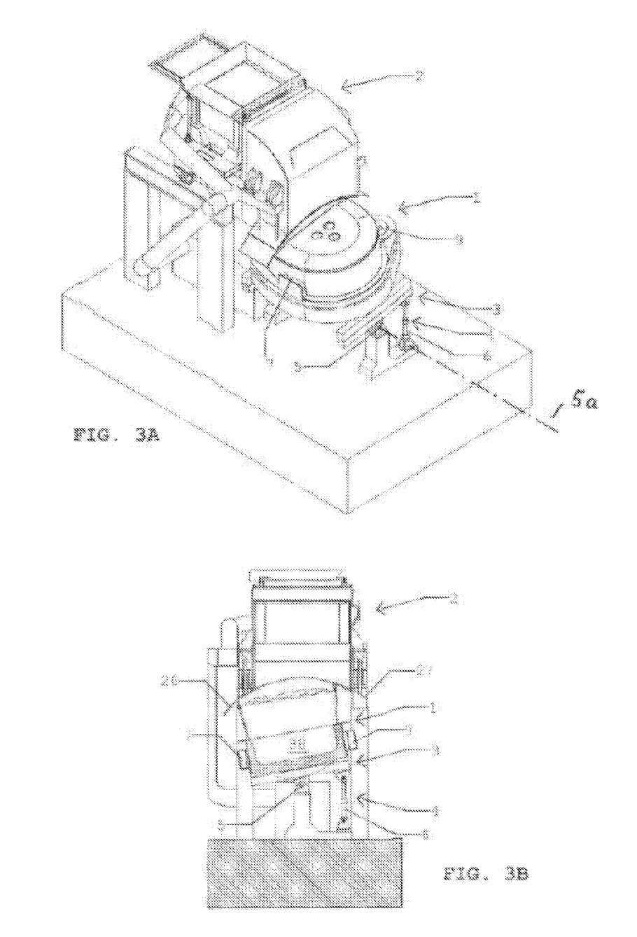

FIG. 2A and FIG. 2B show a perspective view or a sectional view, respectively, of the melting device in a tapping position;

FIG. 3A and FIG. 3B show a perspective view or a sectional view, respectively, of the melting device according to the first embodiment in a deslagging position;

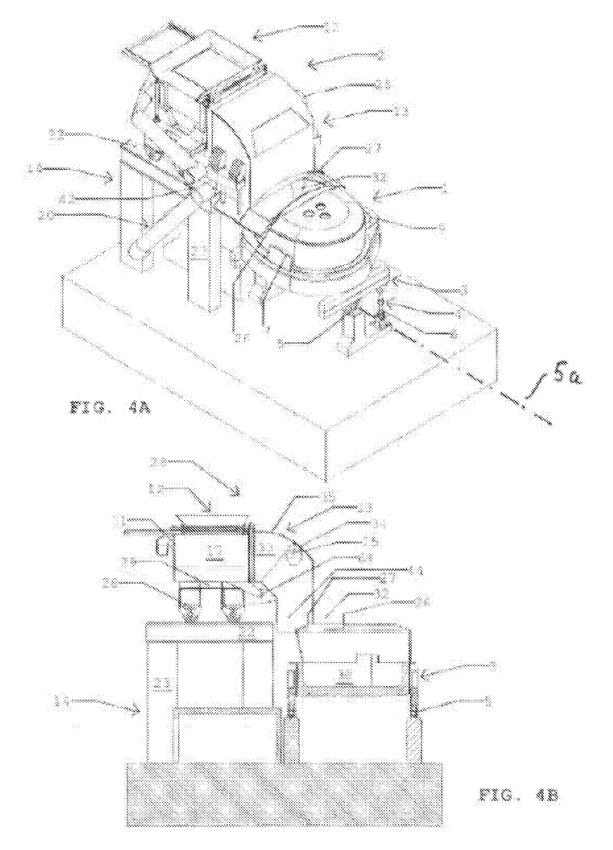

FIG. 4A and FIG. 4B show a perspective view or a sectional view, respectively, of the melting device according to the first embodiment in a maintenance position;

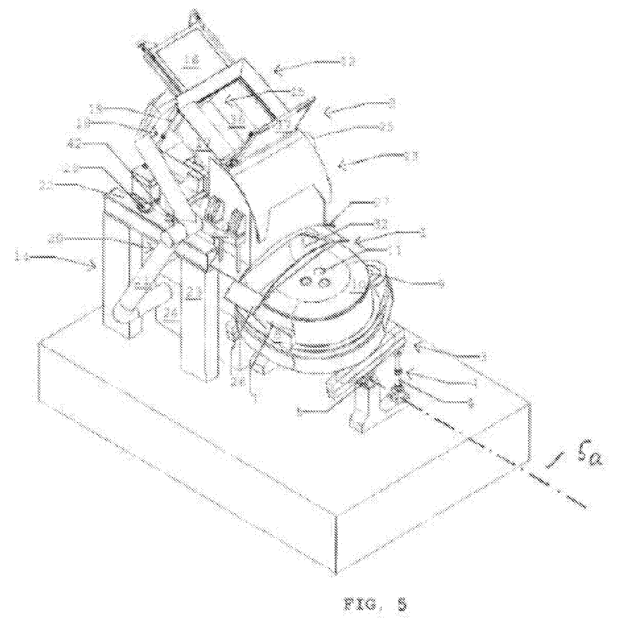

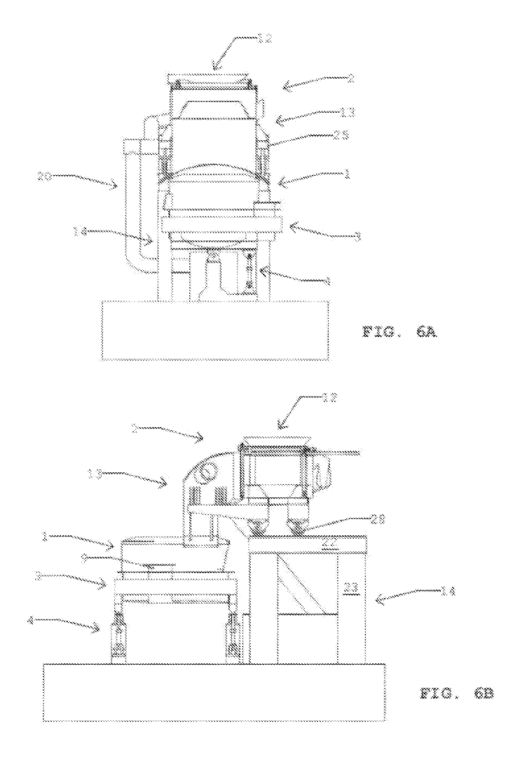

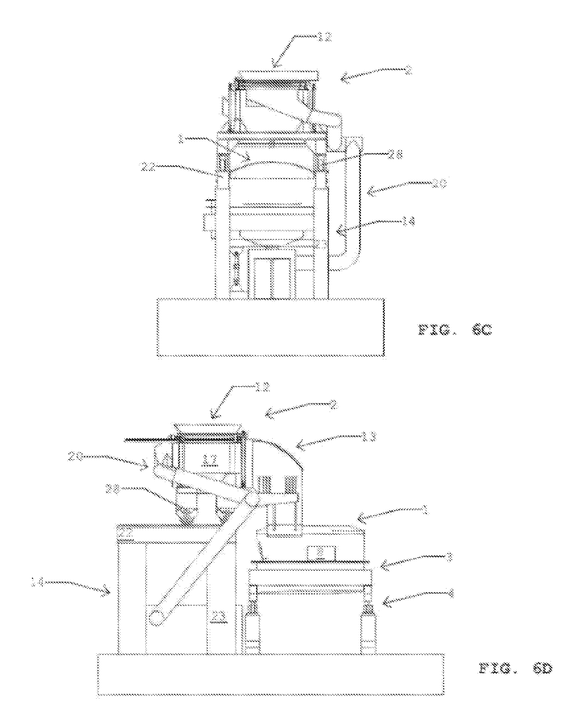

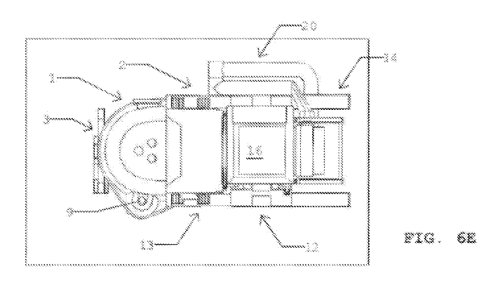

FIG. 5 shows a perspective view of the melting device according to the first embodiment in the maintenance position with the bunker tilted;

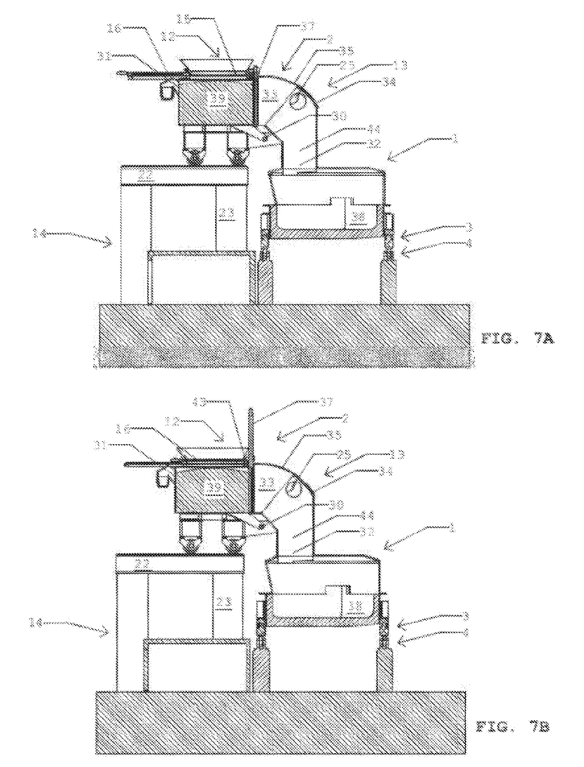

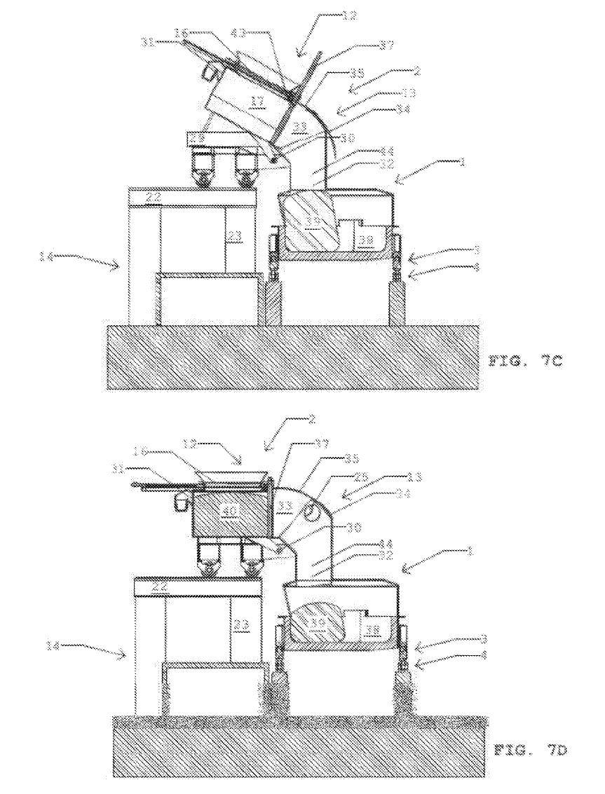

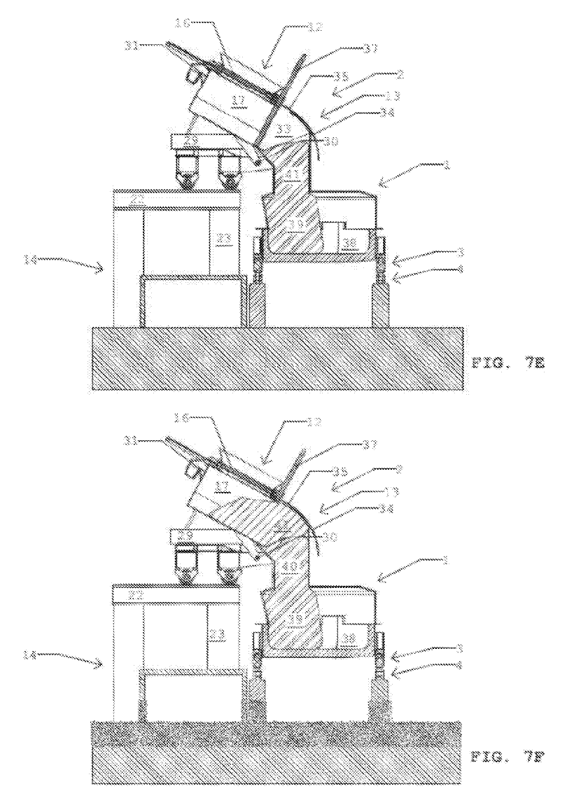

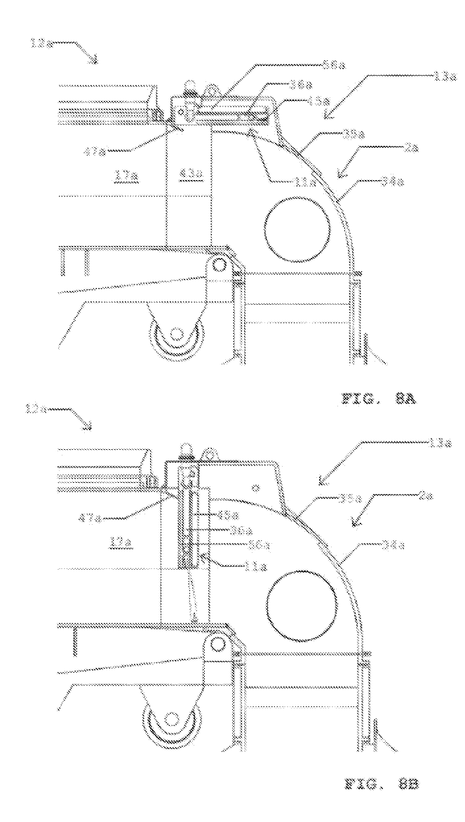

FIGS. 6A, 6B, 6C, 6D, 6E show a front view, a side view, a rear view, a further side view or a top view, respectively, of the melting device according to the first embodiment;

FIG. 7A shows a first sectional view of the melting device according to the first embodiment during a melting cycle;

FIG. 7B shows a second sectional view of the melting device according to the first embodiment during the melting cycle;

FIG. 7C shows a third sectional view of the melting device according to the first embodiment during the melting cycle;

FIG. 7D shows a fourth sectional view of the melting device according to the first embodiment during the melting cycle;

FIG. 7E shows a fifth sectional view of the melting device according to the first embodiment during the melting cycle;

FIG. 7F shows a sixth sectional view of the melting device according to the first embodiment during the melting cycle;

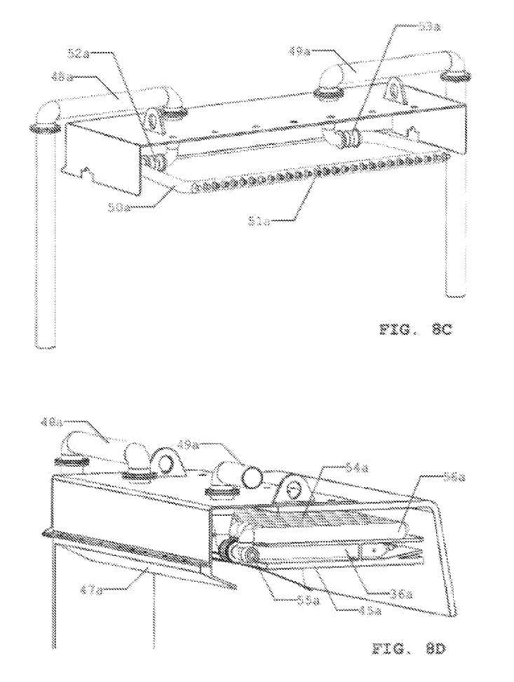

FIG. 8A shows a first sectional view of a feed shaft of the melting device according to a second embodiment;

FIG. 8B shows a second sectional view of the feed shaft of the melting device according to the second embodiment;

FIG. 8C shows a view of a blower of the melting device according to the second embodiment;

FIG. 8D shows a view of a furnace gas inhibiting device of the melting device according to the second embodiment;

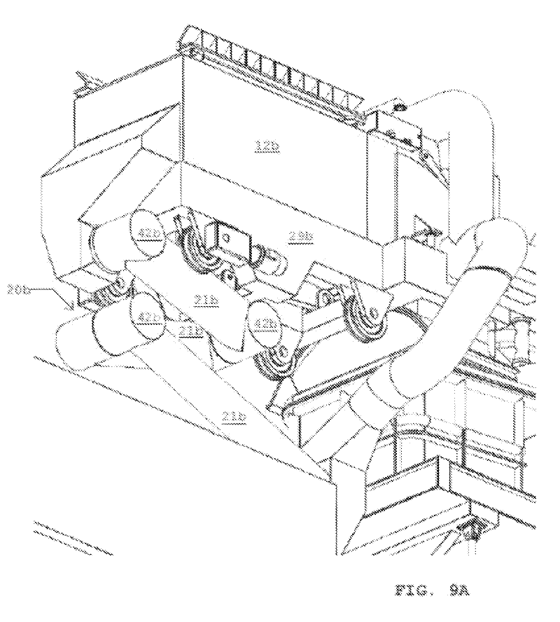

FIG. 9A shows a part view of a melting device according to a third embodiment;

FIG. 9B shows a part view of the melting device according to the third embodiment with the bunker tilted;

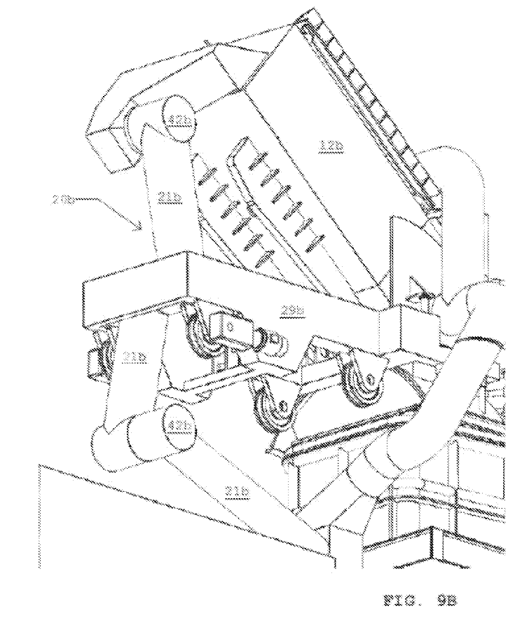

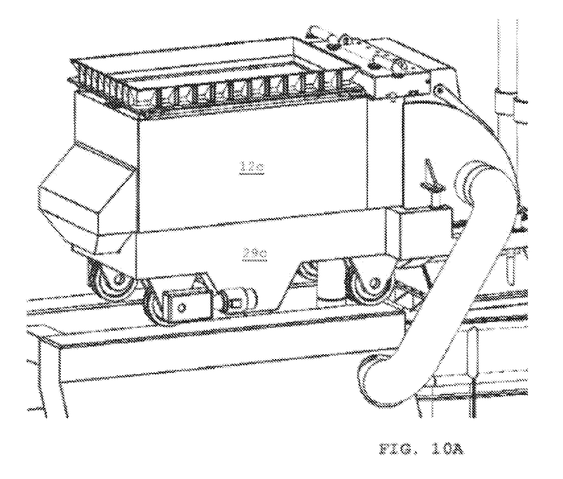

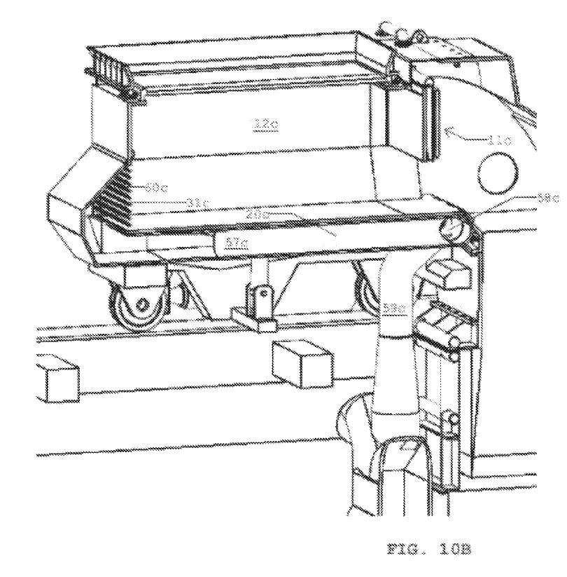

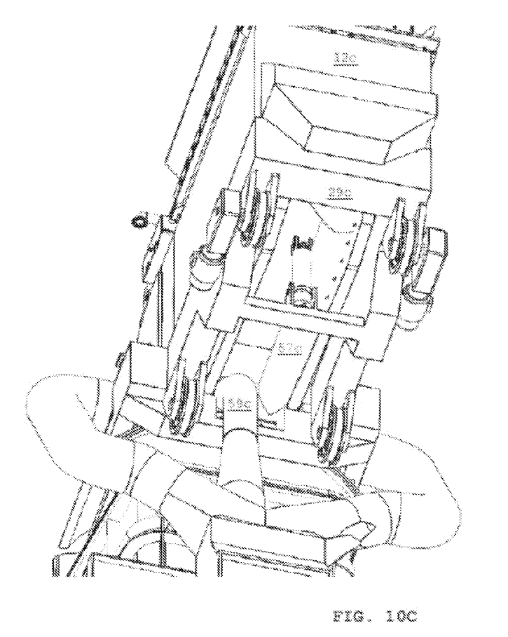

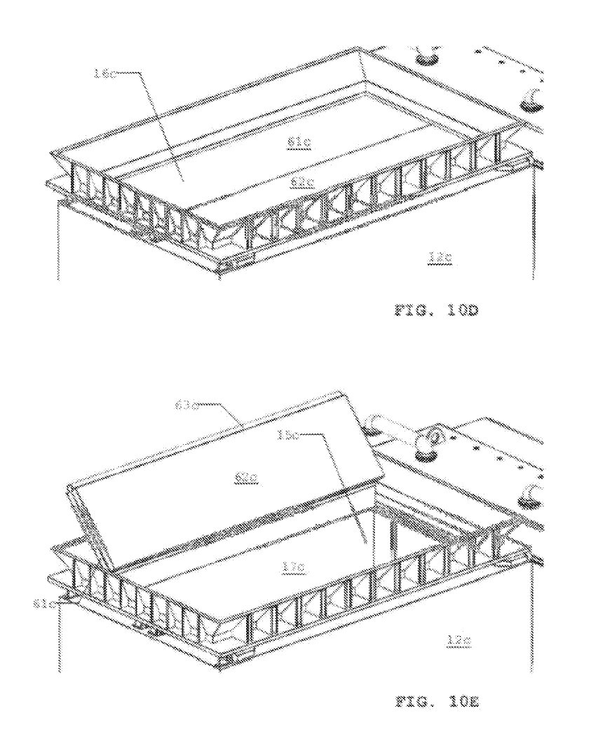

FIG. 10A shows a part view of a melting device according to a fourth embodiment;

FIG. 10B shows a sectional view through a bunker of the melting device according to the fourth embodiment;

FIG. 10C shows a view from below of the bunker of the melting device according to the fourth embodiment;

FIG. 10D shows a view of a closed closure element of the melting device according to the fourth embodiment;

FIG. 10E shows a view of the open closure element of the melting device according to the fourth embodiment;

FIG. 11A shows a part view of a melting device according to a fifth embodiment with a pivoting device for an additional charging material container in a loading position;

FIG. 11B shows a part view of the melting device according to the fifth embodiment with the pivoting device for the additional charging material container in an unloading position;

FIG. 12 shows a perspective view of an alternative design of a melting device with a platform;

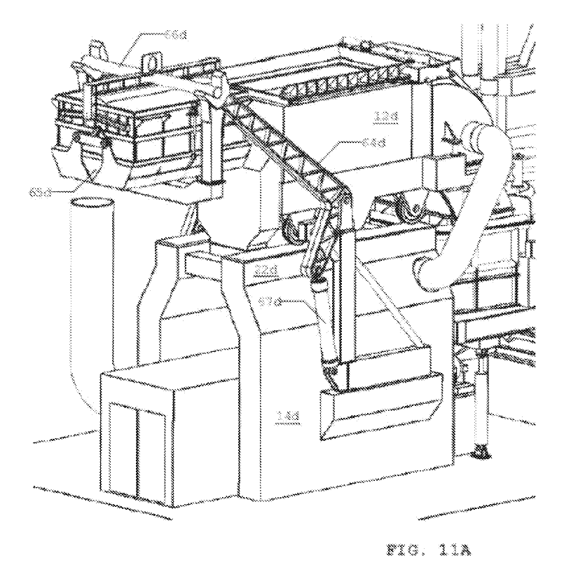

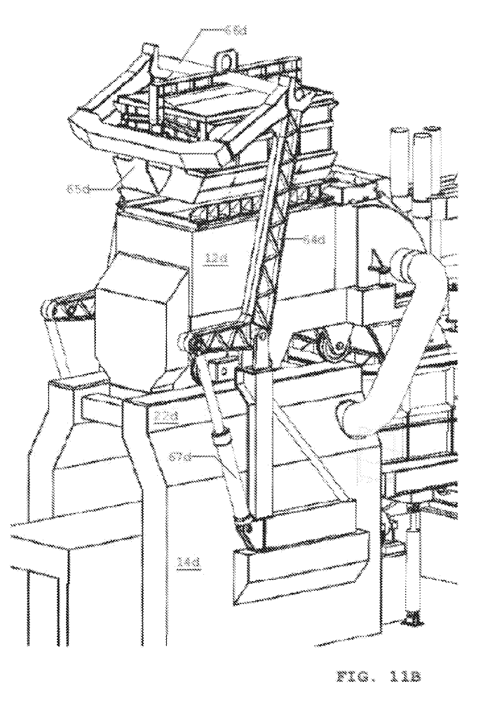

FIG. 13 shows a perspective view of the melting device shown in FIG. 12 with a subsequently provided bunker;

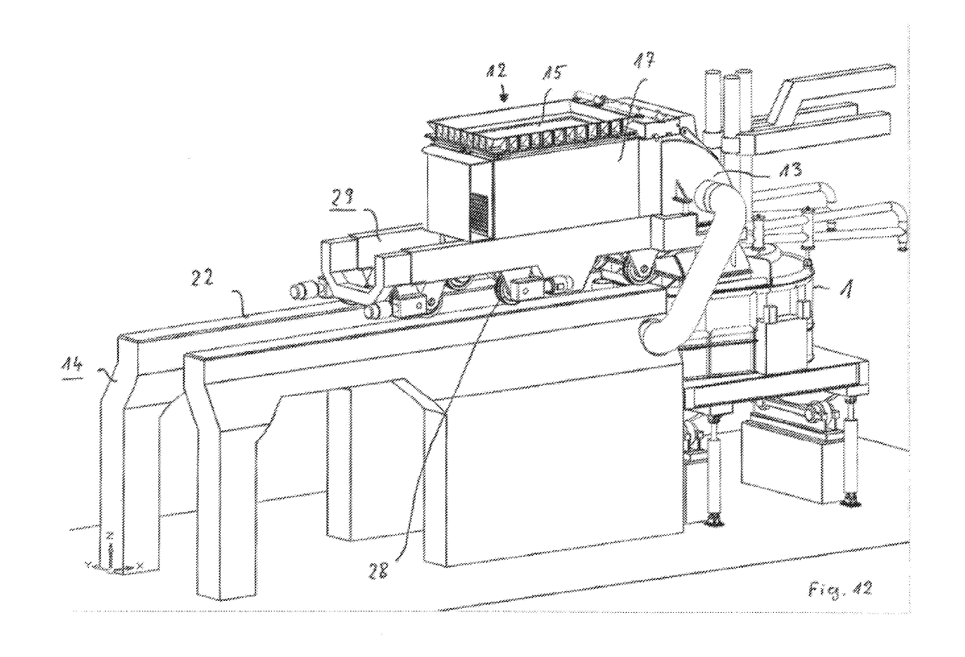

FIG. 14 shows a perspective view of a further development of the melting device shown in FIGS. 12 and 13 with a lifting device;

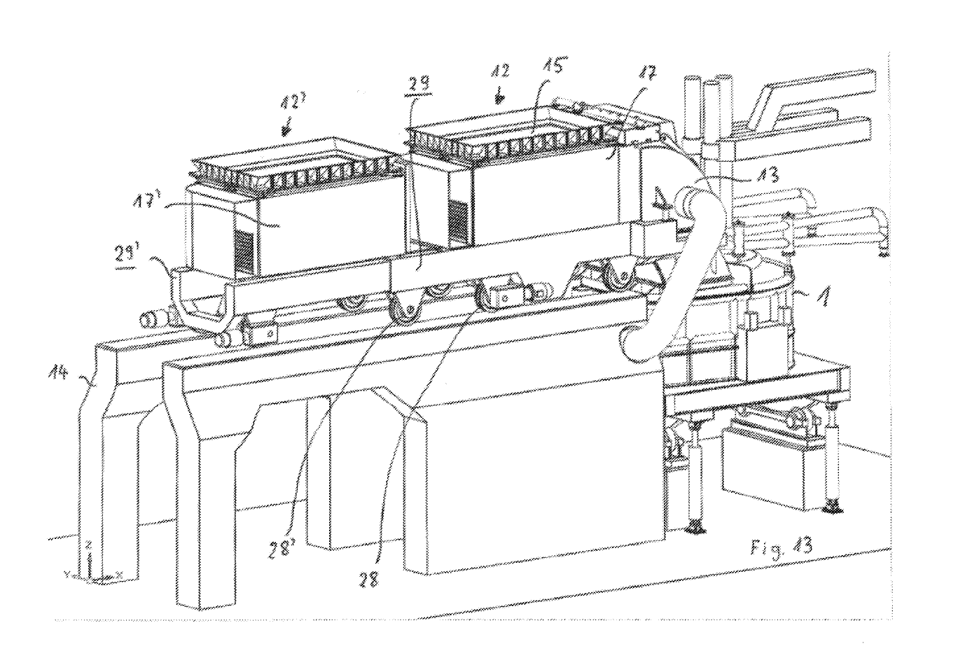

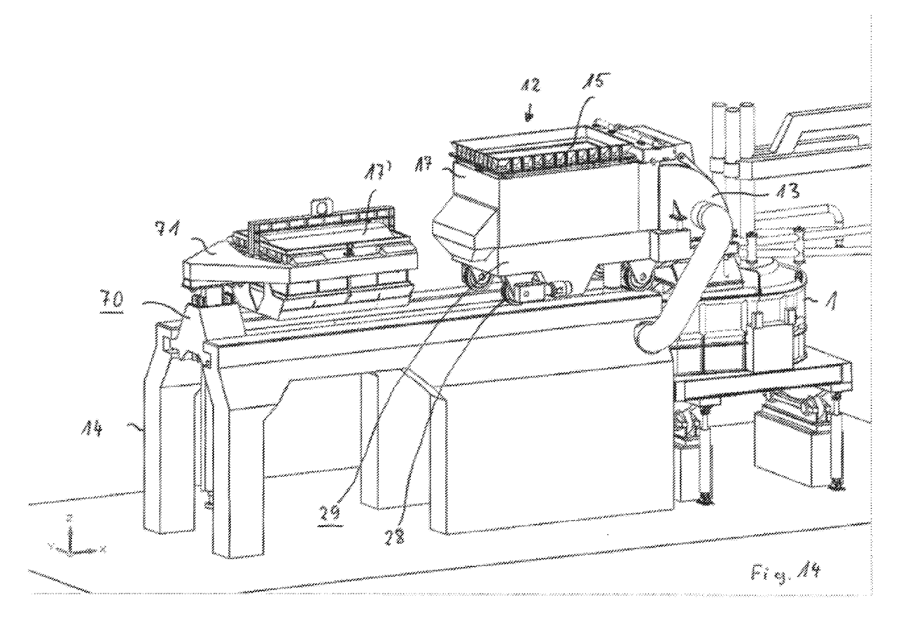

FIG. 15 shows a perspective view of the melting device shown in FIG. 14 in a following method step;

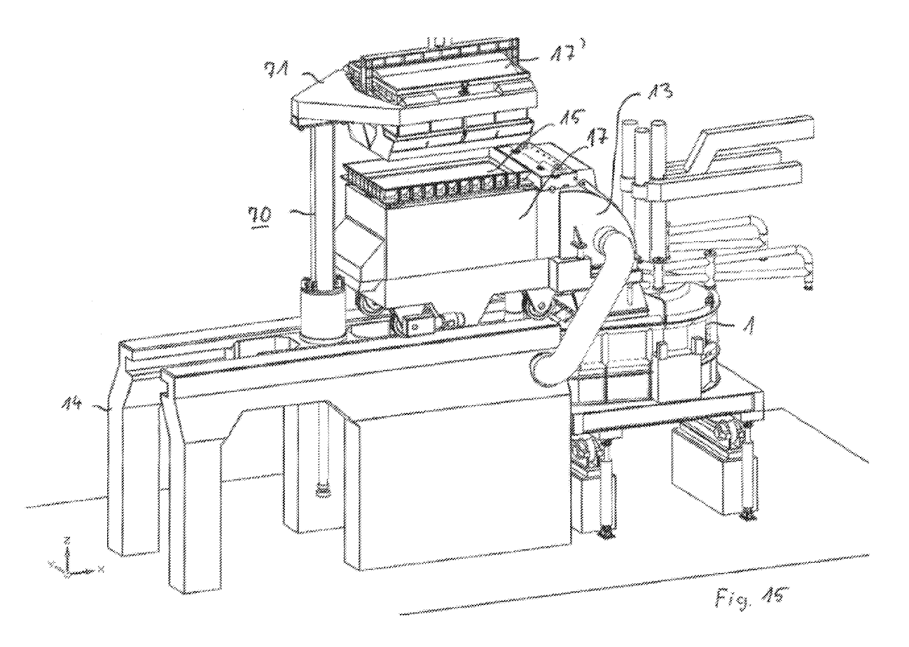

FIG. 16 shows a perspective view of a further alternative melting device with a pivotable lifting device;

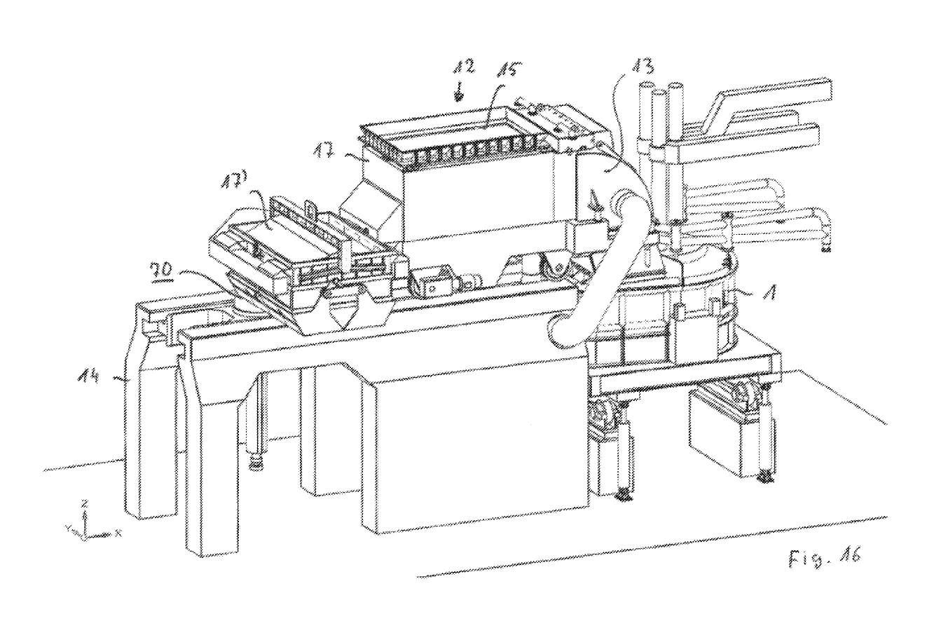

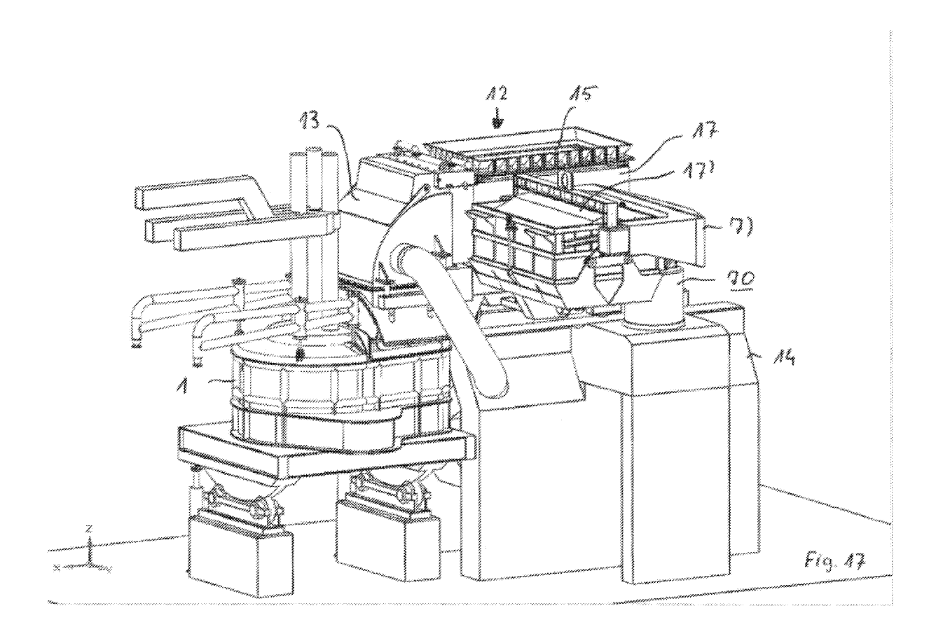

FIG. 17 shows a, once again, perspective view of an alternative design of the melting device with a lifting device offset to the side and

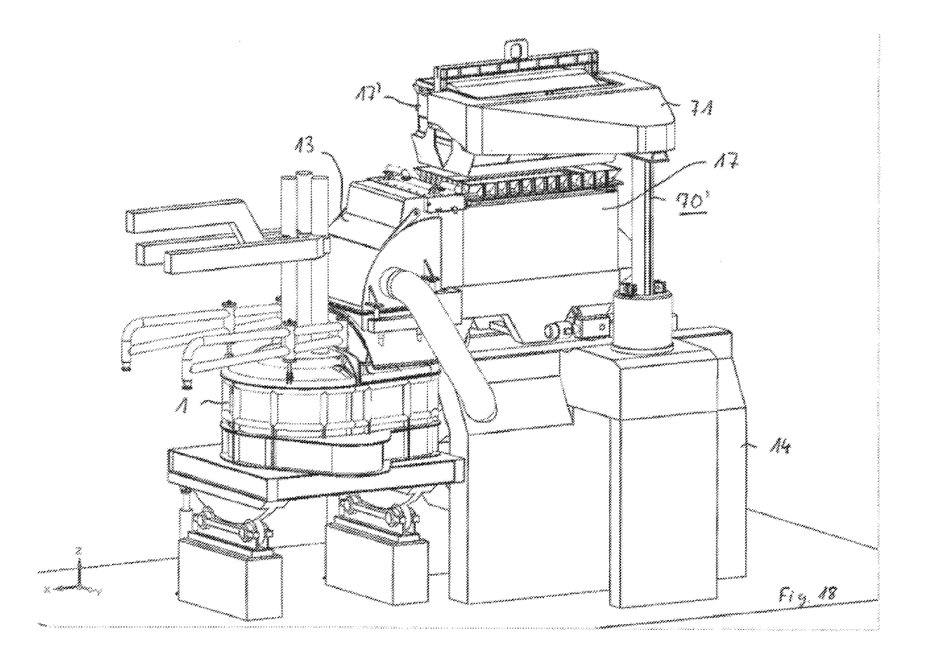

FIG. 18 shows a perspective view of the melting device shown in FIG. 17 in a following method step.

FIG. 1 shows a perspective view of the melting device according to the first embodiment in a melting position. The melting device, which comprises a furnace vessel 1 and a feed device 2, is an electric arc furnace for melting steel scrap.

The furnace vessel 1 is mounted on a holder 3 with two holder components which are provided at opposite ends of the furnace vessel 1. One of said holder components is covered for the most part in FIG. 1. Each of the holder components includes a tilt device 4. The tilt device 4 comprises in each case a pivot joint 5 and a hydraulic cylinder 6 which is controlled by a control means (not show). The furnace vessel 1 includes a bottom vessel and a top vessel on which a furnace vessel cover 10 is situated. Provided on one side in the upper vessel is a slag outlet 7 with a slag door 8 and on the opposite side a melt outlet 9 which is realized as an extended tap hole. The tilt device 4 enables the furnace vessel 1 to be tilted out of the melting position into a deslagging position in which the slag is discharged through the slag outlet 7 into a trough, and into a tap position in which the melt can be poured through the melt outlet 9 into a ladle. A melt position is a position in which a melting method usually takes place. In all melt positions, the furnace vessel 1 and the holder 3 are aligned horizontally. A deslagging position is accordingly a position in which the slag can be discharged through the slag outlet 7. In all deslagging positions the furnace vessel 1 and the holder 3 are inclined such that the slag outlet 7 is lowered. A tap position is accordingly a position in which the melt can be poured out through the melt outlet 9. In all tap positions, the furnace vessel 1 and the holder 3 are inclined such that the melt outlet 9 is lowered. The furnace vessel cover 10 comprises three electrode openings for the introduction of in each case an arc electrode (not shown). Several gas burners (not shown.) are also additionally provided in the furnace vessel 1.

The feed device 2 comprises a bunker 12, a feed shaft 13 and a platform 14. The bunker 12 includes a bunker container 17, a carriage 29 and a tilting device 18. The bunker container 17 includes a front feed opening (not shown) which is closable by a plate-shaped closure element (not shown), and an upper loading opening 15 which is closable by a plate-shaped closure element 16. The plate-shaped closure elements are driven, for example, by a toothed rod mechanism which is controlled by the control means (not shown). The tilting device 18 includes a pivot joint (68, see FIG. 4B) and two hydraulic cylinders 19 which are provided at the rear on opposite sides of the bunker container 17 and are controlled by the control means (not shown). A gas outlet opening (not shown), into which opens out a gas channel 20 which comprises several pipe portions 21 which are connected together pivotably, is provided at the rear of the bunker container 17. Furnace gas is drawn off by a gas suction device 24 through said pipe portions 21. The carriage 29 comprises four rollers 28, two rollers 28 being provided in each case on one side of the carriage 29. Two parallel rails 22, on which in each case two of the rollers 28 rest, are provided on the top of the platform. 14 such that the bunker 12 is drivable along the rails 22. The rollers 28 are driven by a motor (not shown) which is controlled by the control means (not shown). Each of the rails 22 rests on a pillar 23 in each case at its opposite ends. A gas outlet opening 25 is provided at the top of the feed shaft 13. A gas channel (not shown), through which furnace gas is drawn off also by the gas suction device 24, opens out in the gas outlet opening 25. The feed shaft 13 is fixedly connected to the carriage 29 of the bunker 12 such that the feed shaft 13 is drivable together with the bunker 12. A sealing region 26 of the furnace vessel 1 in which a furnace vessel opening (not shown) is realized, is provided at the top of the furnace vessel 10. A sealing region of the feed shaft 13, in which a shaft opening (not shown) is realized, is provided at the bottom of the feed shaft 13. In the operating position shown, the furnace vessel opening and the shaft opening form a passage for charging material from the feed shaft 13 to the furnace vessel 1. Further sealing elements 27 are integrally molded onto both sides of the shaft opening of the feed shaft 13. Complementary sealing elements 26 are integrally molded onto both sides of the opening of the furnace vessel 1. The sealing region of the furnace vessel 1 encloses a convex, cylinder-surface-portion-shaped surface, whilst the sealing region of the feed shaft 13 encloses a complementary, concave cylinder-surface-portion-shaped surface. The two sealing regions abut against one another during the operation of the melting device in such a manner that hardly a gap, however a conceivably narrow gap, is realized between them and that hardly any furnace gas penetrates through the sealing regions out of the melting device to the outside, and that hardly any air is drawn in from the outside.

As an alternative to this, in the event of a larger gap in said region it is also possible to use an air barrier which shields the gap from the outside environment of the melting device. To this end, it is possible to arrange blowers, which shield the gap from the environment by means of an air curtain, for example above the gap on the outside of the feed shaft. The function of such an air curtain is explained at another point in connection with the furnace gas inhibiting device.

FIG. 2A and FIG. 2B show a perspective view or a sectional view, respectively, of the melting device according to the first embodiment in a tapping position. In the tapping position, the furnace vessel 1 is pivoted clockwise about the pivot joints 5 by the tilting device 4 as a result of actuating the hydraulic cylinder 6 in such a manner that the melt outlet 9 is inclined downward, and that the melt in the furnace vessel interior 38 is caused to run through the melt outlet 9 out of the furnace vessel 1.

The sealing region of the furnace vessel is rotated relative to the sealing region of the feed shaft 13. The two sealing regions, however, nevertheless still abut against one another such that hardly any gap is realized between them and that hardly any furnace gas penetrates out of the melting device to the outside through said sealing regions.

FIG. 3A and FIG. 3B show a perspective view or a sectional view, respectively, of the melting device according to the first embodiment in a deslagging position. In the deslagging position the furnace vessel 1 is pivoted anticlockwise about the tilt axis 5a of the pivot joints 5 by the tilting device 4 as a result of actuating the hydraulic cylinder 6 in such a manner that the slag outlet 9 is inclined downward, and that the slag in the furnace vessel interior 38 is caused to run out through the slag outlet 9 out of the furnace vessel 1. The sealing region 26 of the furnace vessel 1 is tilted relative to the sealing region 27 of the feed shaft 13. Portions of the sealing surfaces of the two sealing regions, however, nevertheless are still located opposite one another such that only a narrow gap is realized between said portions of the sealing surfaces such that hardly any furnace gas penetrates out of the melting device to the outside through said sealing regions.

FIG. 4A and FIG. 4B show a perspective view or a sectional view, respectively, of the melting device according to the first embodiment in a maintenance position. A maintenance position is a position in which maintenance usually takes place. The bunker 12 is retracted together with the feed shaft 13 in all maintenance positions. Retracting the bunker 12 on the rails 22 creates access to the furnace vessel opening 32 such that access is possible to the furnace vessel interior 38. The retraction of the bunker 12 together with the feed shaft 13 in a direction parallel to the tilt axis 5a is made possible as a result of the design of the sealing region 26 of the furnace vessel cover 10 as a convex, cylinder-surface-portion-shaped surface and of the sealing region 27 of the feed shaft 13 as a complementary, concave, cylinder-surface-portion-shaped contour without the feed shaft 13 having to be raised because there is a gap between the convex sealing surface of the sealing region and the complementary concave sealing surface (contour) of the feed shaft 13. In addition, a pivot joint 42 between two pipe portions of the gas channel 20 is triggered such that access can be gained to the interior of the pipe portions. A shaft connection element 33 is fixedly mounted at the front of the bunker container 17. The feed shaft 13 comprises an upper part 34 with a convex, cylinder-surface-portion-shaped contour and two oppositely situated side parts. The shaft connection element 33 comprises an upper part 35 with a complementary, concave cylinder-surface-portion-shaped surface and two oppositely situated side parts. The upper part 35 overlaps with the upper part 34. The two upper parts 34 and 35 and the side parts of the connection element 33 and of the feed shaft abut against one another during the operation of the melting device in such a manner that hardly any gap is realized between them and that hardly any furnace gas penetrates out of the melting device to the outside through the upper parts 34 and 35 and side parts and that no air or hardly any air is drawn in from the outside.

FIG. 5 shows a perspective view of the melting device according to the first embodiment in the maintenance position with the bunker 12 tilted. The pivot joint 42 between two pipe portions of the gas channel 20 is not triggered. The retraction of the bunker 12 without triggering the pivot joint 42 is made possible as a result of several pivot joints being provided in the gas channel 20.

FIG. 6A, FIG. 6B, FIG. 6C, FIG. 6D and FIG. 6E show a front view, a side view, a rear view, a further side view and a top view of the melting device according to the first embodiment. The melting device is situated in the same operating position in each case.

A melting method, which runs in melting cycles, is explained below by way of FIG. 7A to FIG. 7F. Each cycle includes feeding several charges of steel scrap to the melting device (typically three charges), melting the steel scrap, casting the melt and discharging the slag. Proceeding from a state of the individual parts of the melting device which is shown in FIG. 7A, the following steps are carried out for each charge during the feeding process:
i.) pour the respective charge of steel scrap in through the upper loading opening 15 of the bunker container 17;
ii.) close the upper loading opening 15 as a result of driving the closure element 16;
iii.) open the front feed opening 43 as a result of driving (driving up) the closure element 37, once the front feed opening 43 has been opened, the furnace gas is extracted out of the melting vessel interior 38 through the rear gas outlet opening 31 on the bunker container 17;
iv.) tilt the bunker container 17 out of its starting position so that the respective charge of steel scrap slides into the feed shaft 13;
v.) tilt the bunker container 17 back into its starting position;
vi.) close the front feed opening 43 as a result of driving (driving down) the closure element 37, once the front feed opening 43 has been closed, the furnace gas is extracted out of the melting vessel interior 38 through the upper gas outlet opening in the feed shaft 13; and
vii.) open the top loading opening 15 as a result of driving the closure element 16.

Steps i.) to vii.) normally run in the order given, it being unimportant whether step v.) is carried out after step vi.) or vii.).

FIG. 7A shows a first sectional view of the melting device according to the first embodiment during a melting cycle after pouring a first charge of steel scrap 39 into the bunker container 17 (after step i.).

FIG. 7B shows a second sectional view of the melting device according to the first embodiment during the melting cycle after closing the upper loading opening 15 as a result of driving the closure element 16 and after opening the front feed opening 43 as a result of driving (driving up) the closure element 37 (after step iii.) for the first charge of steel scrap 39. Furnace gas is extracted out of the melting vessel interior 38 through the passage from the melting vessel opening 32 to the shaft opening 44, the feed shaft 13, the feed opening 43, the bunker container 17 and finally the gas outlet opening 31, the charging material 39 being pre-heated in the bunker container 17 by the furnace gas.

FIG. 7C shows a third sectional view of the melting device according to the first embodiment during the melting cycle after the bunker container 17 has been tilted forward (after step iv.) for the first charge of steel scrap 39.

FIG. 7D shows a fourth sectional view of the melting device according to the first embodiment during the melting cycle after a second charge of steel scrap 40 has been poured into the bunker container 17 (after step i.).

FIG. 7E shows a second sectional view of the melting device according to the first embodiment during the melting cycle after the bunker container 17 has been tilted forward (after step iv.) for the second charge of steel scrap 40. A charging material pillar has been realized in the feed shaft 13.

FIG. 7F shows a sixth sectional view of the melting device according to the first embodiment during the melting cycle during the tilting of the bunker container 17 out of its starting position (after step iv.) for a third charge of steel scrap 41. The interval between steps iv.) and v.) can depend on the charge. The interval for the third charge 41 between steps iv.) and v.) is considerably longer than for the first charge of steel scrap 39 as it is necessary to wait until the charging pillar has melted down so far that the charge of steel scrap 41 slides completely out of the bunker container 17 into the feed shaft 13.

The steps i.) to iii.) can be carried out for the first charge, which is associated with a following melting cycle, before the tap has been effected for the preceding melting cycle. In this case, it is possible for some steel scrap which is associated with the first charge to drop into the feed shaft 13. However, this does not provide a problem. The following melting cycle, in this case, directly follows the preceding melting cycle and even overlaps with it. The tapping and the discharging of the slag are effected prior to step iv.) for the first charge of the following melting cycle.

In the following description of further embodiments of the present invention, the same numbers as for the first embodiment are used as reference symbols for functionally identical elements followed by an additional letter.

For the following embodiments only the features which deviate substantially from the first embodiment are shown. Elements of the further embodiments which are not described are therefore realized by at least substantially identical elements. The features of various embodiments can be combined with one another insofar as this is technically possible.

FIG. 8A shows a first sectional view of a feed shaft 13a of the melting device according to a second embodiment. The corresponding detail for the first embodiment is to be found in FIG. 4B. Instead of a closure element (37, see FIG. 7A), however, a furnace gas inhibiting device 11a is provided in a feed opening 43a which extends over the entire width of the rectangular feed opening 43a. The furnace gas inhibiting device 11a is situated in the up position and. includes a cooling device 30a, a blower 36a and a partition wall 45a, and is pivotable about a pivot axis by means of a drive (not shown) which is controlled by means of a control means (not shown) and is able to drive the furnace gas inhibiting device 11a between the up position and a down position. An impact protection means 47a, which comprises an inclined impact surface and protects the furnace gas inhibiting device 11a from damage caused by charging material sliding out of a bunker container 17a into a feed shaft 13a, is provided in front of the furnace gas inhibiting device 11a.

FIG. 8B shows a second sectional view of the feed shaft of the melting device according to the second embodiment. The furnace gas inhibiting device 11a is pivoted downward about the pivot axis by means of the drive and is situated in the down position. Air flows out of outlet openings of the blower 36a. The outflowing air prevents an airflow from one side of the feed opening 43a to the other side thereof and, consequently, furnace gas flowing out of the furnace gas vessel into the bunker container 17a and from there further through the loading opening to the outside.

FIG. 8C shows a view of the blower 36a of the melting device according to the second embodiment. The blower 36a includes a first end pipe portion 48a, a second end pipe portion 49a and a central pipe portion 50a. The central pipe portion 50a comprises substantially the form of a rectangle which is on a side which is situated at the top when the furnace gas inhibiting device 11a is in the down position, and is moved to a horizontal region which is situated at the bottom when the furnace gas inhibiting device 11a is in the down position. Several outlet openings 51a, which are directed downward when the furnace gas inhibiting device 11a is in the down position, are realized in the horizontal region of the central pipe portion 50a. The two ends of the central pipe portion 50a are rotatably connected to the two end pipe portions 48a, 49a by means of two pipe joints 52a, 53a. The rotational axes of the two pipe joints 52a, 53a are both in the same horizontal axis. As the two end pipe portions 46a, 49a are fixedly connected to the housing of the feed shaft 13a, the rotational axis at the same time forms the pivot axis about which the furnace gas inhibiting device 11a is pivotable. In the down position, compressed air is pressed into the blower at the two end pipe portions 49a, 50a. The compressed air flows to the horizontal region of the central pipe portion 50a and escapes downward by means of the outlet openings 51a.

FIG. 8D shows a view of a furnace gas inhibiting device 11a of the melting device according to the second embodiment. The cooling device 30a includes tubular cooling lamellas 54a and is connected at its oppositely situated ends by two pipe joints 55a to a feed line (not shown) and a discharge line (not shown) for coolant, through which the coolant is supplied to the cooling lamellas 54a and is removed from said cooling lamellas. The rotational axes of the two pipe joints 55a of the cooling device 30a are identical to the rotational axis of the two pipe joints 52a, 53a of the furnace gas inhibiting device 11a. When a furnace gas inhibiting device 11a is provided, a melting method is carried out which, apart from step iii.) being replaced by step iii.)′ and step vi.) being replaced by step vi.)′, is identical to the one that is explained by way of FIG. 7A to FIG. 7F. Step iii.)′ is as follows: move furnace gas inhibiting device 11a into the up position and switch off the blower 36a, once the blower 36a has been switched off, the furnace gas being extracted out of the melting vessel interior through the rear gas outlet opening on the bunker container. Step vi.) is as follows: move furnace gas inhibiting device 11a into the down position and switch on the blower 36a, once the blower 36a has been switched on, the furnace gas being extracted out of the melting vessel interior through the upper gas outlet opening in the feed shaft 13a.

FIG. 9A shows a part view of a melting device according to a third embodiment. The platform is not shown in order not to hide essential elements. The furnace gas is sucked out of the bunker 12b through a gas outlet opening on the rear wall of the bunker 12b via a gas channel 20b with several pipe portions 21b which are connected together by means of pivot joints 42b.

FIG. 9B shows a part view of the melting device according to the third embodiment with the bunker 12b tilted. The tilting of the bunker 12b is made possible by rotating the pivot joints 42b.

FIG. 10A shows a part view of a melting device according to a fourth embodiment.

FIG. 10B shows a sectional view through a bunker 12c of the melting device according to the fourth embodiment.

The furnace gas is drawn off through a gas outlet opening 31c on the rear wall of the bunker 12c via a gas channel 20c. A grid 60c is provided in the gas outlet opening. A first channel portion 57c of the gas channel 20c runs first of all beneath the floor of a bunker container 17c and opens out in a pipe joint 58c. The pipe joint 58c lies in the rotational axis of the bunker container 12c when it is tilted. A second channel portion 59c, through which the furnace gas is drawn off, begins in the pipe joint 58c.

FIG. 10C shows a view from below of the bunker of the melting device according to the fourth embodiment.

FIG. 10D shows a view of a closed closure element 16c of the melting device according to the fourth embodiment.

The closure element 16c includes a first closure plate 61c and a second closure plate 62c.

FIG. 10E shows a view of the open closure element of the melting device according to the fourth embodiment. The two closure plates 61c, 52c are connected together by a hinge 63c. When the first closure plate 61c is pivoted upward by a drive (not shown) which is controlled by a control means, the second closure plate 62c is flipped onto the first closure plate 61c and a loading opening 15c is opened.

FIG. 11A shows a part view of a melting device according to a fifth embodiment having a pivoting device for an additional charging material container 65d in a loading position. The pivoting device includes two support arms 64d which are mounted on oppositely situated sides of a platform 14d. The two support arms 64d are driven by hydraulic cylinders 67d which are controlled by a control means. A holder for a bearing axle 66d which supports the additional charging material container 65d, is realized in each case on the upper ends of the support arms 64d. The bearing axle 66d is received at its two oppositely situated ends in each case in one of the holders.

FIG. 11B shows a part view of the melting device according to the fifth embodiment with the pivoting device for the additional charging material container 65d in an unloading position. The two support arms 64d are pivoted forward by means of the hydraulic cylinder 67d such that the additional charging material container is arranged immediately above the bunker 12d. To empty the additional charging material container 65d, an opening in the floor thereof is opened.

FIG. 12 shows a perspective view of the melting device. In the case of said realization, a platform 14 is associated with the furnace vessel 1. The platform 14 is provided with rails 22, on which a drivable bunker 12 with a bunker container 17 is arranged. In this case, the bunker 12 is provided with a carriage 29 which is provided with rollers 28 which are placed onto the rails 22 of the platform 14 such that the bunker 12 is drivable on the platform 14. In the position shown, the bunker container 17 is docked at the feed shaft 13 and can be emptied into the feed opening 43 of the feed shaft. 13 by means of a tilting device, which is not shown here. The advantage of this is that the bunker container 17 simply has to be raised to a height such that it can be placed onto the carriage 29. As a result, both the crane for the placing of the bunker container 17, and also the building in which the melting device is arranged, can be realized at a lower height than if the bunker container 17 had to be raised to a height above the feed shaft 13.

FIG. 13 shows a further development of the realization of the melting device according to FIG. 12 to the effect that in addition a further bunker 12′ can be placed onto the platform 14 such that once the bunker container 17 of the bunker 12 has been emptied, said bunker 12 can be raised from the platform 14 by means of the mentioned crane and then the subsequently provided bunker 12′ can be moved to the feed opening of the feed shaft 13 via the rails 22 of the platform 14. In the case of said solution, continuous feeding of the feed shaft 13 is ensured, the advantages that both the crane and the building in which the melting device is arranged being able to be realized at a lower height being maintained.

FIG. 14 shows a further development of the melting device according to the invention to the effect that in addition a lifting device 70 is associated with the platform 14, the lifting device 70 also being drivable along the platform 14 by means of a further rail guide which is incorporated in the platform. As can also be seen from FIG. 14, the lifting device 70 is provided with a receiving device 71 for a further bunker container 17, which is raised by means of the lifting device 70′ and is then movable in the direction of the bunker 12 which has already docked at the feed shaft 13 until finally, according to FIG. 15, the further bunker container 17′ is arranged above the bunker container 17 which is already docked at the feed shaft 13 and can be emptied into the loading opening 15 of the bunker container 17 by means of an emptying opening 71 of the bunker container 17′. In the case of this solution, it is not a further bunker, but just a bunker container 17′ which has to be raised above the platform 14 in such a manner that said further bunker container 17′ can be received by the receiving device 71 of the lifting device 70, the further movement of said subsequently provided bunker container 17′ being implemented by means of the lifting device 70. The advantages of a lower building and crane height are maintained here too.

In a further improved realization according to FIG. 16, the lifting device 70 is additionally provided with a pivoting device in such a manner that the subsequently provided further bunker container 70 can also be deposited transversely, i.e. offset about 90°, with respect to the alignment of the bunker 17 which has already been moved up to the feed shaft 13 on the platform 14 and is receivable by means of the receiving device 71 of the lifting device 70. By means of the pivotable lifting device 70, the subsequently provided further bunker container 17′ can then be pivoted in such a manner that it is arranged above the loading opening 15 of the bunker 17 according to the representation in FIG. 15 and the charging material contained in the bunker container 17 can then be emptied into the bunker container 17 of the bunker 12. The advantage of said solution consists, along with the advantages already named, in that in the case of said realization, on account of the option of depositing the subsequently provided bunker container 17′ transversely with respect to the platform 14, the platform 14 is able to be realized in a correspondingly shorter manner such that in this respect the space required for the melting device according to the invention is reduced.

In a, once again, alternative design according to FIG. 17, it is also possible for the lifting device 70 not to be incorporated in the platform 14, but rather to be arranged separately to the side next to the platform 14 such that the length of the platform 14 is reduced by the space otherwise required for the lifting device 70. The advantage of only having to raise the subsequently provided bunker container 70′ up to the height of the receiving device 71 of the lifting device 70 before the subsequently provided bunker container 70 is received by the receiving device 71 of the lifting device 70, is also maintained in this context. In the case of said realization according to FIG. 18, the lifting device 70 is also provided with a pivoting mechanism which allows it first of all to raise the subsequently provided bunker container 17′, which is received offset by 90° in the receiving device 71 of the lifting device 70, and then to pivot it in such a manner that the subsequently provided bunker container 17′ is arranged above the loading opening 15 of the bunker 12 such that the subsequently provided bunker container 17′ can be emptied into the bunker container 17 of the bunker 12.

### LIST OF REFERENCES

1 Furnace vessel
2 Feed device
3 Holder
4 Tilting device
5 Pivot joint
5a Tilt axis
6 Hydraulic cylinder
7 Slag outlet
8 Slag door
9 Melt outlet
10 Furnace vessel cover
11 Furnace gas inhibiting device
12,12′,12a,12b,12c,12d Bunker
13, 13a Feed shaft
14, 14d Platform
15, 15c Loading opening
16, 16c Closure element
17,17a,17a,17c Bunker container
18 Tilting device
19 Cylinder
20,20b,20c Gas channel
21,21b Pipe portion
22 Rails
23 Pillar
24 Gas extraction device
25 Gas outlet opening
26 Sealing element
27 Further sealing element
28 Rollers
29 Carriage
30,30a Cooling device
31,31c Further gas outlet opening
32 Furnace vessel opening≈melt gas opening
33 Shaft connection element
34 Upper part of teed shaft (13)
35 Upper part of shaft connecting element (33)
36,36a Blower
37 Closure element
38 Furnace vessel interior≈melting vessel interior
39 First charge of steel scrap (charging material)
40 Second charge of steel scrap (charging material)
41 Third charge of steel scrap (charging material)
42, 42b Pivot joint
43,43a Feed opening
44 Shaft opening
45a Partition wall
47a Impact protection means
48,48a First end pipe portion
49,49a Second end pipe portion
50,50a Central pipe portion
51,51a Outlet openings
52,52a Pipe joints
53, 53a Further pipe joints
54,54a Cooling lamellas
55,55a Pipe joints of cooling device (30,30a)
57c First channel portion
58c Pipe joint
59c Second channel portion
60c Grid
61c First closure plate
62c Second closure plate
63c Hinge
64d Support arms
65d Additional charging material container
66d Support axle
67d Hydraulic cylinder
68 Pivot joint
70,70′ Lifting device
71 Receiving device

1-18. (canceled)

19. A melting device having a feed shaft and a tilting device, by means of which a furnace vessel with a furnace vessel cover is tiltable about a tilt axis into different tilt positions, where the furnace vessel cover has a charging opening, to which a flat sealing element is connected on each of two sides, such that the outside boundary of said sealing elements and the outside boundary of the charging opening define a furnace vessel sealing region with a sealing surface which surrounds the charging opening, said furnace vessel sealing region is realized as a convex, cylinder-surface-portion-shaped surface, a further sealing element is also connected on each of two sides of the opening of the feed shaft facing the charging opening in such a manner that the outside boundary of said further sealing elements and the outside boundary of said opening of the feed shaft define a shaft sealing region with a complementary concave, cylinder-surface-portion-shaped sealing surface, portions of the sealing surfaces of the two sealing regions are located opposite one another in each case in the different tilt positions of the tilting device.

20. The melting device as claimed in claim 19, wherein the furnace vessel sealing region and the shaft sealing region form in each case portions of circular cylinder surfaces, and the circular cylinder axes of said surfaces coincide with a tilt axis of the tilting device.

21. The melting device as claimed in claim 19, wherein a charging material bunker, which is arranged upstream of the feed shaft, comprises a feed opening with a feed opening closure element and a loading opening with a loading opening closure element.

22. The melting device as claimed in claim 19, wherein the feed shaft comprises a gas outlet opening.

23. The melting device as claimed in claim 19, wherein the charging material bunker comprises a further gas outlet opening.

24. The melting device as claimed in claim 23, wherein a gas channel opens out in the gas outlet opening, in that the gas channel comprises a channel portion which runs beneath a floor of a bunker container of the charging material bunker to a pipe joint which lies in a rotational axis of the bunker container.

25. The melting device as claimed in claim 19, wherein a pivotable furnace gas inhibiting device is provided with a blower.

26. The melting device as claimed in claim 25, wherein the furnace gas inhibiting device is provided in the feed shaft.

27. The melting device as claimed in claim 19, wherein a pivoting device is provided for an additional charging material container in order to pivot the additional charging material container from a loading position to an unloading position and vice versa, and in that the pivoting device comprises two support arms, one support arm each on each oppositely situated side of the charging material container in order to support the additional charging material container on the two oppositely situated sides of the charging material container.

28. The melting device as claimed in claim 19, wherein the melting device includes a feed device with at least one bunker, a feed shaft and a platform, the at least one bunker includes in each case a bunker container, a carriage with rollers and a tilting device, the at least one bunker is tiltable by means of the tilting device in such a manner that charging material is fillable into the feed shaft through a feed opening which faces the feed shaft and is closable by means of a closure element.

29. The melting device as claimed in claim 28, wherein at least one further bunker is to be arranged on the platform and the bunker container of said further bunker is interchangeable by means of a crane for the bunker container of the bunker once the bunker container of the bunker has been emptied into the feed shaft.

30. The melting device as claimed in claim 29, wherein a lifting device for a further bunker container, which lifting device is drivable on the platform, is associated with the platform in such a manner that by means of said lifting device, the further bunker container is raisable above a closable loading opening of the bunker container once said bunker container has been emptied into the feed shaft and said further bunker container can be emptied into the open loading opening of the bunker container, the further bunker container is insertable into the lifting device and is removable out of the lifting device again by means of the crane.

31. The melting device as claimed in claim 28, wherein the further bunker container is pivotable by means of the lifting device.

32. The melting device as claimed in claim 31, wherein the lifting device is arranged to the side next to the platform.

33. The melting device as claimed in claim 19 having a furnace vessel and a feed device, the feed device comprises a charging material shaft and a charging material bunker, the charging material shaft is realized as a charging material pre-heating device and said charging material pre-heating device is set up to pre-heat charging material in the feed shaft by means of furnace gas, wherein the charging material bunker is realized as a further charging material pre-heating device, and in that said further charging material pre-heating device is set up to pre-heat charging material in the charging material bunker by means of furnace gas.

34. A melting method which is carried out by a melting device with a furnace vessel and a feed device, the feed device comprises a feed shaft and a charging material bunker having a bunker container, said method having the following steps:
pre-heat the charging material in the bunker container by means of furnace gas, and
forward the charging material from the bunker container into the feed shaft, characterized by the following further step:
pre-heat the charging material in the feed shaft by means of furnace gas,
wherein the melting method includes several charges of charging material, for one of the several charges of charging material the following steps are carried out one after another:
pour the charge into the bunker container through a loading opening;
close the loading opening;
open the feed opening;
pre-heat the charge in the bunker container by means of furnace gas;
forward the charge from the bunker container into the feed shaft; and
pre-heat the charge in the feed shaft by means of furnace gas.

35. The melting method as claimed in claim 34, wherein the melting method includes several charges of charging material, for one of the several charges of charging material the following steps are carried out one after another:
pour the charge into the bunker container through a loading opening whilst the entry of furnace gas into the bunker container is inhibited by a furnace gas inhibiting device;
close the loading opening;
pre-heat the charge in the bunker container by means of furnace gas;
forward the charge from the bunker container into the feed shaft; and
pre-heat the charge in the feed shaft by means of furnace gas.
